(19) United States
(12) Patent Application Publication
(10) Pub. No.: US 2009/0166271 A1
(43) Pub. Date: Jul. 2, 2009

(54) WATER CIRCULATION TREATMENT SYSTEM IN HOUSING ESTATE

(75) Inventor: Yubo DONG, Beijing (CN)

Correspondence Address: YING CHEN;Chen Yoshimura LLP, 255 S. GRAND AVE., # 215, LOS ANGELES, CA, 90012, US

(73) Assignee: Beijing Jinaohuarong Science and Technology Co., Ltd., Beijing (CN)

(21) Appl. No.: 12/121,031

(22) Filed: May 15, 2008

(30) Foreign Application Priority Data
Dec. 28, 2007 (CN) 200710304545.1

(51) Int. Cl. B01D 35/14; B01D 35/30; B01D 36/04

(52) U.S. Cl. 210/85; 210/243; 210/150

(57) ABSTRACT

The invention relates to a water circulation treatment system in housing estate comprising an oxidative biologic filter chamber, a sloping plate sedimentation chamber, an electric biology organic sewage processor and a carbon absorption chamber, said oxidative biologic filter chamber, said sloping plate sedimentation chamber, said electric biology organic sewage processor and said carbon absorption chamber are connected in sequence, wherein the electric biology organic sewage processor includes a shell and a plurality pairs of electrodes, the plurality pairs of electrodes placed in the shell of the electric biology organic sewage processor and surrounded by filter materials, the extending directions of the electrodes are perpendicular to that of water flow in the shell of the electric biology organic sewage processor. This system can purify discharged water which meet sewage discharged standards to a high degree of purification to be used as drinking water.

### BACKGROUND OF THE INVENTION

1. Field of the Invention

The invention relates to a water circulation treatment system in housing estate, in particular to a water treatment system used in housing estate for realizing the recycling of the water.

2. Description of the Related Art

Recycling is an important way to save water resource. In order to realize this aim, the sewage treatment system has to guarantee that the purifying degree of the discharged water accords with the recycling requirements; but at present, the scope of the water recycling is comparatively narrow and the yielding water's quality of the common sewage treatment system is just according with the related sewage discharging standards. Separated water supply with different qualities for different usages is tried in some living districts. The recycled water has just simple utilization, serving as landscape water, flushing water and irrigating water, etc. Along with the increasingly strain of water resource, the scope of water recycling is enlarged gradually. On the condition with doable technique, the recycled water can be used on various occasions such as industrial and agricultural occasions just like common industrial and agricultural water. In order to realize the objective, the discharged sewage at present needs further treatment.

The prior water treatment technique mainly develops at two directions. One is for the treatment of sewage with high pollutant content comprising the biochemical treatment of the anaerobic, oxidative and oxygen-poor microorganism. The treated water can meet the sewage discharging standards. Such standard indicates that the water has comparatively small influence upon the environment and does not cause environment pollutions after being accommodated by the environment; but the water under these standards can only serve to be irrigating water and landscape water and so on. The other direction is for treatment of highly purified water. The main technique is membrane treatment. The treated water has comparatively high purity and contains organic matters and microorganism at a very slow level, being used as drinking water in usages with high purity requirements such as pharmacy. But the treatment cost is very high. So, a purifying technique with good effect and proper cost is needed in line with the recycling requirements of water.

### SUMMARY OF THE INVENTION

In order to overcome the above defects, the invention provides a water circulation system in housing estate. This system is of a lower treatment cost and a higher purification of water.

The technical solution of the invention is that: a water circulation treatment system in housing estate comprising an oxidative biologic filter chamber, a sloping plate sedimentation chamber, an electric biology organic sewage processor and a carbon absorption chamber, said oxidative biologic filter chamber, said sloping plate sedimentation chamber, said electric biology organic sewage processor and said carbon absorption chamber are connected in sequence, wherein the electric biology organic sewage processor includes a shell and a plurality pairs of electrodes, the plurality pairs of electrodes placed in the shell of the electric biology organic sewage processor and surrounded by filter materials, the extending directions of the electrodes are perpendicular to that of water flow in the shell of the electric biology organic sewage processor.

The work process of the system is that an inlet pipe of the system connects with an outlet pipe of prior domestic sewage treatment system, which discharges water accords with related discharging standards. After entering this system, the water gets further biochemical treatment in the oxidative biologic filter chamber so that partial organic matters in the water transfer into carbon dioxides and harmless matters, contents of organic pollutants in water being reduced, while most of suspended matters in the water deposits in the high efficient sloping plate sedimentation chamber. The electric biology organic sewage processor is a main purifying apparatus of the system, in which most of pollutants remained in the water are decomposed. And then, water is purified by the carbon absorption chamber to a high degree of purification.

After being electrified, the arranged electrodes form partial electrolysis in the water; the generated oxidants and reducing agents carry out oxidation or deoxidization reaction to the organic matters in the water so as to make the organic matters directly contacted with the surrounding living creatures, beneficial to improving the speed of the biologic treatment and reducing the density of the electrolysis resultant at any time so as to make the electrolysis be balanced, beneficial for the directional development of the resultant and improving the effect of the electrolysis; therefore, the mutual promotion of the biologic treatment and the electrolysis treatment is formed so as to make the whole effect better than the two separated treatment processes of electrolysis treatment and biologic treatment. Even though the mechanism of the biologic reaction under the electrolysis is not completely known because of the complexity of the biology, but the mutual promotion in water purification is affirmative.

The useful effects of the invention are that the procedure for the system to purify water is reasonable and the structure of the system is simple with a good purifying effect. This system can purify discharged water which meet sewage discharged standards to a high degree of purification to be used as drinking water.

### BRIEF DESCRIPTION OF THE DRAWING

FIG. 1 is the schematic view of an embodiment of the invention.

### DETAILED DESCRIPTION OF THE PREFERRED EMBODIMENTS

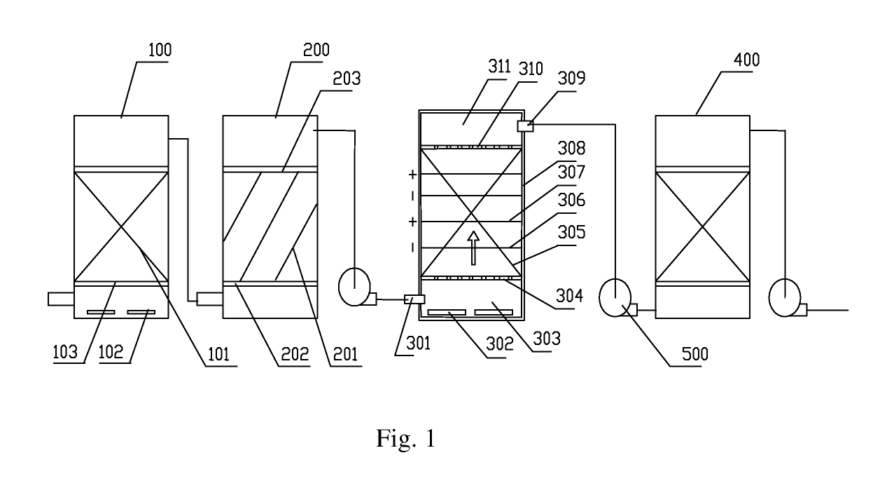

As shown in FIG. 1, the invention provides a water circulation treatment system in housing estate, comprising an oxidative biologic filter chamber 100, a sloping plate sedimentation chamber 200, an electric biology organic sewage processor 300 and a carbon absorption chamber 400. The electric biology organic sewage processor comprises a shell 308 which is provided with an internal space for forming a water current channel. In channel there are a plurality pairs of electrodes and biologic filter materials 305 surrounding the electrodes. Each pair of electrodes consists an anode 307 and a cathode 306 of an extending direction perpendicular to that of the water current channel and the water flow in the shell.

The oxidative biologic filter chamber is internally provided with biologic filter materials 101 which is attached with active organic sludge. The biologic filter materials can be suspended in the shell and made of plastic with various structures or soft materials so as to provide comparatively high biologic density, beneficial to reducing the resistance and the renovation of the sludge so as to keep enough biologic activity.

In the oxidative biologic filter chamber, the biologic filter materials are suspended at the middle section of the chamber; two pore plates 103 are respectively equipped above and below the middle section to equalize the pressure and current speed of water. One or more aerators 102 are equipped at the bottom of the chamber to provide air needed by reactions of oxidative biochemistry.

The middle part of the sloping plate sedimentation chamber is provided with a sloping plate 201. Sloping brackets 203, 202 are respectively arranged above and below the sloping plate; a sludge sedimentation area is arranged at the downward side of the sloping plate so as to collect the sludge sliding down from the sloping plate.

The carbon absorption chamber can includes a disinfecting apparatus so as to kill the microorganism through the infliction of disinfector.

As shown in FIG. 1, the space in the shell of the electric biology organic sewage processor is divided into a water outlet chamber 311, a reaction chamber and a water inlet chamber 303 from top to bottom by two water distributing plates 310 and 340; the water outlet chamber positioned at the upper part is provided with a water outlet pipe 309; the water inlet chamber positioned at the lower part is provided with a water inlet pipe 301 and the bottom is provided with an aerator 302; and the reaction chamber in the shell is internally provided with biologic filter materials 305 and horizontally extended positive and negative electrodes which can be a pair of electrodes that are respectively distributed at the upper part and the lower part, or a pair of electrodes that are respectively distributed on the left and the right, or plural pairs of electrodes. According to the space arrangement, when the electrodes are vertically and horizontally distributed in 3D manner; the positive and negative electrodes are distributed alternately both in horizontal and vertical directions; and positive and negative electricity is interspersed in the filter materials.

The frame in the filter materials can be organic macromolecule filter material, inorganic filter material or inert embedding mediums such as sodium acetylide and PVA and so on.

The filter materials are piled or suspended in the reaction chamber; the filling rate of the filter materials is 20 percent to 95 percent.

The top of the shell can be provided with an explosion prevention alarming device.

The positive and negative electrodes can adopt electrodes, which are made of carbon, iron, stainless steel, porous nickel, palladium, platinum or germanium and have catalyzing activities.

The distance between the adjacent positive and negative electrodes can be 20 to 500 mm.

The shape of the cross-section of the shell can be round or rectangular.

The shell can adopt a vertical structure with the water inlet positioning at the downward side. The water current flows from the bottom to top on the shell so as to reduce the resistance of the water current.

The shell also can adopt a horizontal structure. The water current flows horizontally in the shell and the manner is beneficial for forming a comparatively long length.

The electric biology organic sewage processor adopted by the invention is a water treatment technique with comparatively deep purifying degree, which can oxidize the overwhelming majority of organic pollutants such as paraffin hydrocarbon, fatty alcohol, fatty acid, olefin, phenol, organic acid, aromatic hydrocarbon, dye, polychlorinated biphenyls, surface active agent, and pesticide and so on. On the occasions with comparatively high purifying requirement to the yielding water, the organic pollutant in the water source which gains organic pollution to certain extent still cannot reach the prescribed index just depending on filter treatment and oxidative biochemical treatment. For the deep purifying treatment on the condition, people always adopt membrane filter method and so on to treat, but the treatment methods get certain restriction in the comparatively big scale water treatment because the treatment volume is relatively small and the treatment cost is comparatively high. As problem that the water contains minim organic matter pollution is more and more serious, such as the minim natural organic matters in the water source, various toxic and harmful artificially synthesized organic matters, disinfecting outgrowth and the possibly existed trace amount internal secretion interfering matters and lasting organic matters; the insecurity caused by the minim organic pollutant also exists in the sewage recycling. The invention does have certain application prospect.

It will be apparent to those skilled in the art that various modification and variations can be made in the device of the present invention without departing from the spirit or scope of the invention. Thus, it is intended that the present invention cover modifications and variations that come within the scope of the appended claims and their equivalents.

What is claimed is:

1. A water circulation treatment system in housing estate comprising:
an oxidative biologic filter chamber;
a sloping plate sedimentation chamber;
an electric biology organic sewage processor; and
a carbon absorption chamber,
wherein the oxidative biologic filter chamber, sloping plate sedimentation chamber, electric biology organic sewage processor and carbon absorption chamber are connected in sequence, and
wherein the electric biology organic sewage processor includes a shell and a plurality of pairs of electrodes, the plurality pairs of electrodes being placed in the shell of the electric biology organic sewage processor and surrounded by filter materials, an extending directions of the electrodes being perpendicular to that of water flow in the shell of the electric biology organic sewage processor.

2. A system of claim 1, wherein the oxidative biologic filter chamber includes biologic filter materials, two pore plates and one or more aerators, wherein the biologic filter materials are suspended in a middle section of the oxidative biologic filter chamber, the two pore plates are respectively disposed above and below the middle section, and the one or more aerators are disposed at a bottom of the oxidative biologic filter chamber.

3. A system of claim 1, wherein the sloping plate sedimentation chamber includes a plurality of sloping plate, sloping plate brackets and a sludge sedimentation area, wherein the plurality of sloping plates are disposed in the sloping plate brackets placed in a middle part of the sloping plate sedimentation chamber, and the sludge sedimentation area is at a bottom side of the sloping plate sedimentation chamber.

4. A system of claim 2, wherein the sloping plate sedimentation chamber includes a plurality of sloping plate, sloping plate brackets and a sludge sedimentation area, wherein the plurality of sloping plates are disposed in the a sloping plate brackets placed in a middle part of the sloping plate sedimentation chamber, and the sludge sedimentation area is at a bottom side of the sloping plate sedimentation chamber.

5. A system of claim 1, wherein the carbon absorption chamber includes a disinfecting apparatus.

6. A system of claim 4, wherein the carbon absorption chamber includes a disinfecting apparatus.

7. A system of claim 1, wherein the electric biology organic sewage processor further includes two water distributing plates, wherein the two water distributing plates are disposed horizontally in the shell of the electric biology organic sewage processor and divide an internal space of the shell into a water outlet chamber, a reaction chamber and a water inlet chamber from top to bottom, wherein a bottom of the water inlet chamber is provided with one or more aerator, and wherein the reaction chamber is provided with biologic filter materials.

8. A system of claim 7, wherein the biologic filter materials in the electric biology organic sewage processor are piled or suspended, wherein a filling rate of the biologic filter materials in the reaction chamber is 20 percent to 95 percent.

9. A system of claim 8, wherein a number of pairs of electrodes is more than one, wherein positive and negative electrodes of the more than one pairs of electrodes are distributed alternately.

10. A system of claim 9, wherein the electric biology organic sewage processor is provided with an explosion prevention alarming device at a top of the shell.

11. A system of claim 3, wherein the electric biology organic sewage processor further includes two water distributing plates, wherein the two water distributing plates are disposed horizontally in the shell of the electric biology organic sewage processor and divide an internal space of the shell into a water outlet chamber, a reaction chamber and a water inlet chamber from top to bottom, wherein a bottom of the water inlet chamber is provided with one or more aerator, and wherein the reaction chamber is provided with biologic filter materials.

12. A system of claim 11, wherein the biologic filter materials in the electric biology organic sewage processor are piled or suspended, wherein a filling rate of the biologic filter materials in the reaction chamber is 20 percent to 95 percent.

13. A system of claim 12, wherein a number of pairs of electrodes is more than one, wherein positive and negative electrodes of the more than one pairs of electrodes are distributed alternately.

14. A system of claim 13, wherein the electric biology organic sewage processor is provided with an explosion prevention alarming device at a top of the shell.

15. A system of claim 6, wherein the electric biology organic sewage processor further includes two water distributing plates, wherein the two water distributing plates are disposed horizontally in the shell of the electric biology organic sewage processor and divide an internal space of the shell into a water outlet chamber, a reaction chamber and a water inlet chamber from top to bottom, wherein a bottom of the water inlet chamber is provided with one or more aerator, and wherein the reaction chamber is provided with biologic filter materials.

16. A system of claim 15, wherein the biologic filter materials in the electric biology organic sewage processor are piled or suspended, wherein a filling rate of the biologic filter materials in the reaction chamber is 20 percent to 95 percent.

17. A system of claim 16, wherein a number of pairs of electrodes is more than one, wherein positive and negative electrodes of the more than one pairs of electrodes are distributed alternately.

18. A system of claim 17, wherein the electric biology organic sewage processor is provided with an explosion prevention alarming device at a top of the shell.
